(19) United States
(12) Patent Application Publication
(10) Pub. No.: US 2011/0173977 A1
(43) Pub. Date: Jul. 21, 2011

(54) HP Generator

(76) Inventor: Antonio Ancona, Crofton, MD (US)

(21) Appl. No.: 12/462,765

(22) Filed: Aug. 10, 2009

(51) Int. Cl. F03G 7/00

(52) U.S. Cl. 60/641.6

(57) ABSTRACT

Ancona Power Generator (APG) is a closed loop thermodynamic system which uses the heat pump principle to convert heat into mechanical energy which can be used to drive an electric generator or a machine.

The APG can be used to:
1. Generate of electric power for homes and commercial uses,
2. Recapture electric power station heat absorbed by cooling towers,
3. Provide partial or full propulsion for means of transportation such as automobiles, trucks, trains, boats, ships, and possibly low flying aircrafts.

The APG main components include:
1. Air blower fan or a water pump
2. Heat absorption coil
3. Compressor
4. Condenser Tank
5. Gas Turbine
6. Electric generator

The air blower (water pump) supplies air (water) to the heat absorption coils and to the system gas. The compressor pumps the gas into a condenser tank where it is condensed into a liquid at high temperature. The condensed liquid is allowed to expand into high temperature gas which is used to turn a gas turbine which turns an electric generator to produce electricity or a simple rotating mechanical energy.

### CROSS REFERENCE TO RELATED APPLICATIONS

None

### STATEMENT REGARDING FEDERALLY SPONSORED RESEARCH OR DEVELOPMENT

Not applicable. This invention is not a Federally Sponsored Research.

### REFERENCE TO SEQUENCE LISTING

All invention application information is contained in the Technical description; There is no other information being submitted at this time.

### BACKGROUND OF THE INVENTION

The invention was developed from basic physics and thermodynamic laws in combination with common Heating Ventilation and Air Conditioning (HVAC) and fluid dynamic engineering.

### DETAIL DESCRIPTION OF THE INVENTION

### Technical Description

The Ancona Power Generator (APG) is a thermodynamic closed loop system which uses the heat pump principle to convert heat from air, water or other source into mechanical energy which can be used to generate electricity or drive a machine. The APG system includes the following basic components:

1. Air blower fan or a water pump
2. Gas evaporator and heat absorption coil
3. Air or water
4. Freon, Puron, or better compressible gas
5. Compressor pump driven by an electric motor

### 6. Condenser

7. Expansion valve
8. High Temperature, high Pressure, high volume gas expansion valve; the HTP valve.
9. Gas Turbine (motor)

### 10. Electric Generator

11. Motor and Electric Generator Combination in a single sealed package

### 12. Rectifier/Charger

### 13. Battery

14. AC-DC voltage converter
15. Overall system controller
16. Temperature sensor
17. Pressure sensor
19. Check valve
19. Gas and liquid Piping
20. Control and power wiring

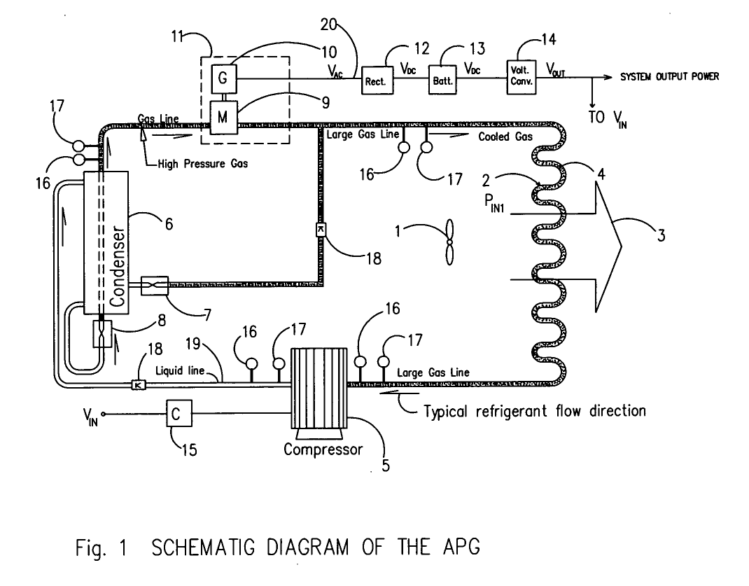

Items 1, 2, 3, 4, 5, and 6 above are self explanatory common components of a heat pump system. Item 7 is a typical heat pump expansion valve used to provide the gas flow needed to maintain the condenser with hot compressed liquid gas. Item 8 is a typical heat pump expansion valve modified to function at high temperature, high pressure, and high volume. This valve would be electronically or mechanically controlled to control the motor speed, torque, and output power. Item 9, the gas turbine, is the item which converts high temperature, high pressure gas into mechanical energy. Item 9 is a typical air motor modified to function with a refrigerant gas. Item 10 is an alternating current (AC) [or direct current (DC)] generator which converts mechanical energy into electrical energy. A motor-generator system, item 11, can be used in place of separate motor and generator. Item 11 would be similar to a typical sealed heat pump compressors. Item 12, the rectifier/charger, converts the AC voltage, V_{AC}, into DC Voltage, V_{DC}, and charges the battery, Item 13. Item 14, the AC-DC voltage converter, converts the Battery DC voltage into AC output voltage, Vₒᵤₜ, which can be used for household uses, to feed power to a utility power grid, to run electrical machines, to power any electrical system, and to power the system compressor item 5. Item 15 is the overall system controller which controls all system functions. Items 16 and 17 are sensors which provides the controlling functions which are usually used in heat pump systems. Item 18 is a check valve used to ensure gas flow direction. Item 19, gas and liquid piping, is used to conduct the system refrigerant, and Item 20, controller and power wiring, is used to conduct electric current. All above noted items are referenced in FIG. 1.

The APG function is as follows:
a. An air blower (or pump), Item 1, drives air (or water) through the heat absorption coils adding heat to the cool gas in the expansion coil.
b. The compressor, Item 4, pumps the gas from the expansion coil to the condenser where the compressed gas is liquified. By the compression process the liquified gas is heated to a high temperature. The condenser is well insulated as needed to minimize heat loss from the condenser.
c. The HTP valve, Item 12, allows the liquified gas to expand in a hot high pressure gas, while the expansion valve, Item 18, maintains a cool gas flow through the expansion coil and provides for a continuous heat absorption by the expansion coil.
d. Additional heat is added to the hot gas by passing the hot gas tube through the condenser, item 6.
e. The pressure differential between the gas pressure at the discharge side of the HTP valve and the low cold gas pressure in the expansion coil drives the gas turbine which converts heat energy into mechanical energy. The gas in the process of turning the turbine loses most of its energy (which is converted into mechanical energy) and cools down. The gas cools down further when it enters the heat absorption coil as it expands in the coil and is ready to absorb more heat from the air propelled (or water pumped) past the absorption coil. An expansion tank could be used at the discharge side of the gas turbine to ensure a low turbine discharge pressure.
f. The gas in the expansion tank absorbs heat and repeats the cycle.
g. The electric generator, Item 7, powered by the motor, Item 8, generates variable frequency AC current.
h. The rectifier/charger, Item 9, converts the variable frequency AC current to a DC current and charges the storage battery, Item 10.
i. The storage battery, Item 10, feeds the voltage converter, Item 19, which generates 60 cycle AC current; the output power of the APG. The output electric current can be generated with different frequencies or voltages to conform other voltage and frequency requirements.

Since current heat pump have a coefficient of performance, COP, factor of 3 to 5, the system described above has a potential of producing three times the electric power that it uses to run the compressor and the electric fan. If the condenser, the turbine and all oter hop pipes, are properly insulated it is possible that over 90% of the heat energy pumped to the condenser, Item 6, can be converted into mechanical energy and into electrical energy with a net energy gain of 1 to 2 times the input energy; a total output of 2 to 3 times of the input energy. It is noted that most of energy used to run the compressor is converted into heat and is another source of heat input to the APG. The diagram of FIG. 1 refers to the APG components noted earlier in this APG description.

It is noted that the APG system satisfies the first law of physics, the first law of thermodynamics, and the second law of thermodynamics. These are:

First law of Physics:
“Energy can neither be created nor destroyed, but only transformed.”

First law of thermodynamics:
“The increase in the internal energy of a system is equal to the amount of energy added to the system by heating, minus the amount lost as a result of the work done by the system on its surroundings”

First law of thermodynamics restated:
“Heat and mechanical energy are two different form a of the same physical quantity. Mechanical energy can be changed freely into heat, and if the quantity of heat so obtained when changed to back into mechanical energy, one would have exactly the same amount of mechanical energy as he started with.”

Second Law of thermodynamics:
“Heat energy can be transferred only from a high heat system to a low heat system”.

Second law of thermodynamics restated:
“The spontaneous changes which occur in a system at constant energy tend toward a maximum entropy of the system.”

Since the heat pumps adds heat to the system by absorbing heat from outside the APG system (from low temperature air or water), the gas compressed by the heat pump contains more heat energy than it is used to compress the gas, hence this additional heat can be converted into mechanical energy which is more than the mechanical energy which was used to compress the gas. As previously noted, most of the power used to pump the gas will be converted to heat which becomes a heat input to the system. In other words the energy used to run the compressor is added to the heat used to run the APG turbine.

It is noted that the machine described above is a machine that converts air or water heat energy into electrical energy, it is not a perpetual machine. This machine will not work at low air temperature, probably temperatures lower than 40° F. unless better HPG gases become available. Also it is noted that current refrigerants can function at temperatures below 32° F.

The APG system potential applications include:
1. Generate electric power for homes and commercial uses,
2. Feed the HPG power to the local utility power grid,
3. Recapture electric power station heat normally absorbed by cooling towers or cooling river water,
4. Provide partial or full propulsion for means of transportation such as automobiles, trucks, trains, boats, ships, and possibly low flying aircrafts.

It may be possible that at cruising speed, an automobile could run many miles without using any fuel. The same applies to other means of transportation.

A preliminary test using off the shelf equipment indicated that the above described system will work as described.

Ancona Power Generator (APG) is a closed loop thermodynamic system which uses the heat pump principle to convert heat into mechanical energy which can be used to drive an electric generator or a machine.

The APG can be used to:

1. Generate electric power for homes and commercial uses. In this application the APG would be installed next to a building or on top of a roof to convert air (or ground water) heat into electricity for homes, for commercial building, power stations, and/or machines.

2. Recapture electric power station heat absorbed by cooling towers. In this application the discharge steam from steam generating stations is used to provide the heat to AGP gas in the expansion tank. Hence the cooling tower heat which normally is released to the atmosphere or to a body of water is used by the APG to generate more electricity and possibly doubling the power station efficiency.

3. Provide partial or full propulsion for means of transportation such as automobiles, trucks, trains, boats, ships, and possibly low flying aircrafts.
In a partial automobile propulsion application the APG will use air heat and internal combustion heat energy, normally dissipated to the engine radiation, and charge a storage battery which, when fully charged, will drive an electric motor which take over the propulsion of the automobile. During highway driving most or all of the energy would be obtained from air and no fuel would be required.
In a full automobile propulsion applications a storage battery starts the automobile APG. Once underway the APG would obtain all the heat energy from air as needed to run the APG and keep the storage battery fully charged. In this case a large expansion tank surface area would be required for the absorption of the air heat.
In the train propulsion applications the APG would be similar to the automobile propulsion application.
In the propulsion applications of boats and ships the APG would use water heat or a combination of water and air heat in place of only air heat.
The propulsion of low flying aircraft may be limited to partial propulsion using air heat and engine waist heat. In this case the large aircraft wing surface and fuselage area would be used to obtain air energy while in flight.
